(19) United States
(12) Patent Application Publication
(10) Pub. No.: US 2011/0232646 A1
(43) Pub. Date: Sep. 29, 2011

(54) RESPIRATORY INTERFACE DEVICE WITH FILTRATION MEDIUM

(75) Inventors: Peter Chi Fai Ho, Pittsburgh, PA (US); Michael W. Haas, Trafford, PA (US)

(73) Assignee: KONINKLIJKE PHILIPS ELECTRONICS, N.V., EINDHOVEN (NL)

(21) Appl. No.: 13/132,444

(22) PCT Filed: Nov. 21, 2009
(86) PCT No.: PCT/IB2009/055254

§ 371 Date: Jun. 2, 2011

Related U.S. Application Data
(60) Provisional application No. 61/138,221, filed on Dec. 17, 2008.

(51) Int. Cl. A62B 18/08

(52) U.S. Cl. 128/206.24

(57) ABSTRACT

The present invention provides a respiratory interface device including a first portion having one or more opening, a second portion structured to engage a face of a user, and a filtration element disposed between the first portion and the second portion. The first portion and the filtration element define a first cavity and at least the second portion and the filter element are structured to define a facial cavity when the respiratory interface device is in use. The filtration element is structured to filter gases passing from the first cavity to the second cavity and from the second cavity to the first cavity.

### CROSS-REFERENCE TO RELATED APPLICATIONS

This patent application claims the priority benefit under 35 U.S.C. § 119(e) of U.S. Provisional Application No. 61/138,221 filed on Dec. 17, 2008, the contents of which are herein incorporated by reference.

### BACKGROUND OF THE INVENTION

1. Field of the Invention

The invention relates generally to respiratory interface devices for transporting a gas to and/or from an airway of a user and, more particularly, to a respiratory interface device, such as a mask, that includes a filtration medium.

2. Description of the Related Art

A variety of respiratory masks are known which cover the areas surrounding the nose and/or mouth of a human user and that are designed to create a good fit against the user's face. Typically, gases can be provided at a positive pressure within the mask for consumption by the user. Additionally, such masks can be provided with exhaust systems for handling of exhaled gases.

One requisite of many of these masks, (e.g.) particularly medical respiratory masks, is that they provide filtration of both inhaled and exhaled gases in order to obtain maximum protection from cross-contamination. Highly complex mask designs utilizing multiple parts, while increasing user comfort, generally tend to increase the locations for, and chances of, such cross-contamination.

Several types of respiratory masks for the types of applications mentioned above are known. Such masks generally utilize multiple filters located in the general gas flow path a distance from the mask itself While such designs provide for filtration to a certain extent, such designs still possess many negative attributes such as potential leakage at joints, high flow resistances, and require several filters.

### SUMMARY OF THE INVENTION

In one embodiment the invention provides a respiratory interface device comprising a first portion having one or more openings, a second portion structured to engage a face of a user, and a filtration element disposed between the first portion and the second portion. The first portion and the filtration element define a first cavity and at least the second portion and the filter element are structured to define a facial cavity when the respiratory device is in use. The filtration element is structured to filter gases passing from the first cavity to the second cavity and from the second cavity to the first cavity. The respiratory interface device may include a shell, wherein the first portion is part of the shell, and wherein the second portion comprises a seal element coupled to the shell. The one or more openings may comprise one or more of a gas inlet, an exhaust mechanism, and an entrainment valve. The filtration element may comprise a peripheral seal that sealingly engages the first portion. The filtration element may isolate the first cavity and the one or more openings from the second cavity. A fluid coupling device may be coupled to one of the one or more openings, and the filtration element may isolate the fluid coupling device from the second cavity. The filtration element may be releasably coupled to the first portion. The filtration element may include a filtration surface having a filtration area, wherein the shell has a projection area, and wherein the filtration area is greater than the projection area. The filtration element may have a concave shape. The second portion may be structured to cover at least one of the user's nasal vents and oral vent. The filtration medium may comprise a high-efficient, low resistance bacteria filter. The filtration element may comprise an indicator that provides an indication that the filtration element needs to be replaced. At least a portion of the filtration element may be structured to change color when the filtration element needs to be replaced. The filtration element may be structured to change color when a moisture level in at least a portion of the filtration element reaches a threshold level.

In another embodiment the invention provides a gas filtration method. The gas filtration method comprises: providing a mask having a first portion having one or more openings provided therein and a second portion structured to engage a face of a user; isolating the one or more openings from the second portion by providing a filtration element inside the mask between the first portion and the second portion, wherein the first portion and the filtration element define a first cavity within the mask; attaching the mask to the face of the user, wherein at least the second portion, the filter element and the face of the user define a second cavity; filtering incoming gases passing from the first cavity to the second cavity with the filtration element; and filtering exhaust gases passing from the second cavity to the first cavity with the filtration element. The one or more openings may comprise one or more of a gas inlet, an exhaust mechanism, and an entrainment valve. The filtration element may include a filtration surface having a filtration area, wherein the shell has a projection area, and wherein the filtration area is greater than the projection area. The filtration element may have a concave or shape. The second portion may be structured to cover at least one of the user's nasal vents and oral vent.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise

### BRIEF DESCRIPTION OF THE DRAWINGS

FIG. 1 is an elevational view of a respiratory mask in accordance with an embodiment of the invention;

FIG. 2 is a cross sectional view of the respiratory mask of FIG. 1 taken along line 2-2 showing an internal arrangement in accordance with an embodiment of the invention; and

FIG. 3 is a cross-sectional view of the respiratory mask of FIG. 1 taken along lines 2-2 showing an internal arrangement in accordance with another embodiment of the invention.

### DETAILED DESCRIPTION OF THE EXEMPLARY EMBODIMENTS

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

As employed herein, the term “respiratory interface device” refers to any suitable mechanism for transporting gas to and/or from the airway of a user and expressly includes, but is not limited to, non-invasive patient interfaces such as masks (e.g., without limitation, masks including support elements such as forehead supports and cheek pads and full face masks), nasal masks and combination nasal/oral masks. As also employed herein, the statement that two or more parts or components are “coupled” together shall mean that the parts are joined or operate together either directly or through one or more intermediate parts or components. Finally, as employed herein, the term “number” shall mean one or an integer greater than one (i.e., a plurality).

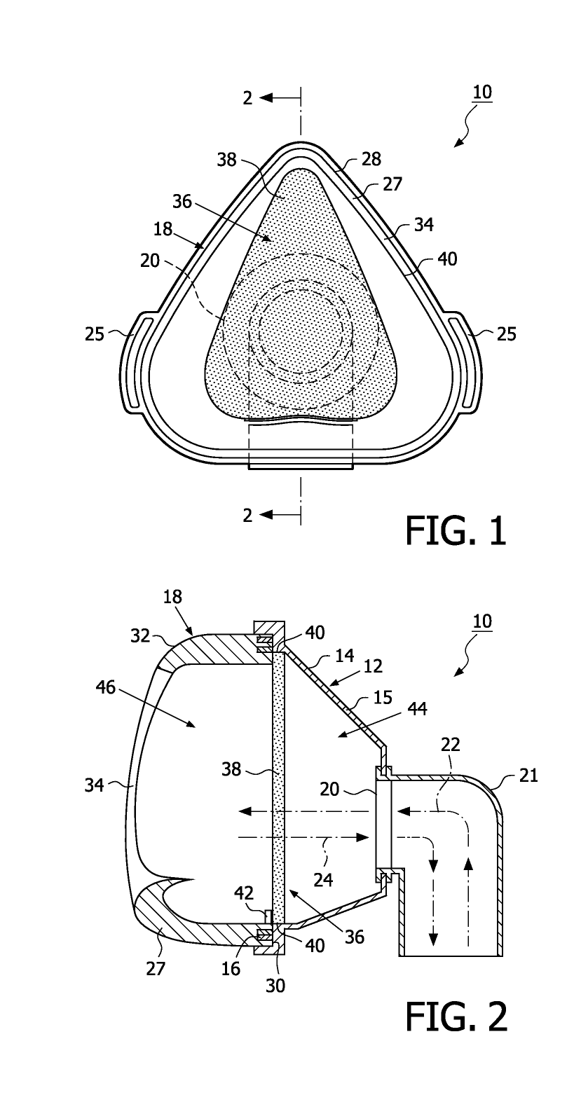

FIGS. 1 and 2, respectively, show a rear elevational view and a cross sectional view of a respiratory mask 10 according to an embodiment of the invention. Respiratory mask 10 includes a body or shell 12 having an outer surface 14 and an inner surface 15 that defines a generally annular surface 16 to which is sealingly affixed a seal element 18 (sometimes referred to as a cushion). Mask shell 12 is preferably, although not necessarily, generally rigid, whereas seal element 18 is preferably a flexible, resilient unitary member made of, for example, an elastomer such as plastic, rubber, silicone, vinyl or foam.

Mask shell 12 also defines an opening 20 to which there is attached a fluid coupling device, such as a swivel conduit 21 (FIG. 2), for carrying fluid, such as a breathing gas, between the chamber defined by mask 10 and an external gas source (not shown), such as a blower or other suitable device. It is to be understood that the present invention contemplates a variety of different fluid coupling devices that could be attached, either permanently or selectively, to the opening 20 to carry fluid to (such as shown by supply gas 22) or from (such as shown by exhaust gas 24) the chamber defined by mask 10. It is to be further understood that although only one opening 20 in shell 12 is shown in the embodiment depicted in FIGS. 1 and 2, multiple openings in the shell could be employed without departing from the scope of the present invention (e.g., without limitation, exhaust valves, entrainments valves).

Mask 10 shown in FIGS. 1 and 2 is a combination nasal/oral mask that accommodates both the nasal and oral regions of the user's face. It is to be understood, however, that the present invention also contemplates other respiratory interface devices such as, without limitation, nasal masks and oral masks. As is conventional, mask body 12 also preferably includes fastening devices, such as tabs 25 (FIG. 1) or the like, that connect to suitable adjustable retention straps (not shown) for retaining the mask with respect to the user's face. Although two such devices are illustrated in FIG. 1 and are generally arrayed at selected corners of the mask 10, it is to be understood that other configurations, arrangements, numbers (including none) and locations of fastening devices can be provided without deviating from the principles of the present invention. Although not illustrated, the present invention contemplates providing one or more exhaust ports or other venting mechanisms at a location or locations, such as in the mask shell 12, the conduit 21 or at a junction between these components, to exhaust gas 24 expired by the user to atmosphere.

Seal element 18 preferably includes a solid, yet highly resilient and self-sustaining compressible, generally annular member 27 comprising a peripheral wall portion 28 having a generally annular base or inner end 30 configured so as to substantially match the opening of the shell 12 defined by the annular surface 16 to which it is attached. Peripheral wall portion 28 further establishes an outer end 32 generally opposite inner end 30. Outer end 32 defines a generally annular contoured surface 34. Contour of surface 34 is preformed to closely approximate the surface contour of a user's facial structure, especially in the areas of the bridge of the nose, the cheeks adjacent the nose and mouth, the space intermediate the lower lip and chin, and the intervening areas contiguous to these.

It is to be understood that the contour of surface 34 can have alternative configurations depending on the type of mask to which the seal element 18 is attached. For a nasal mask, for example (not illustrated), the surface 34 may be contoured to accommodate the area intermediate the nose and upper lip in lieu of the space intermediate the lower lip and chin. In either case, variation in the user's facial structure, especially in the area of the bridge of the nose, for example, makes considerable flexibility of the seal element 18 desirable to accommodate the many different facial contours likely to be encountered.

Referring to FIG. 2, mask 10 further includes a preferably removable filter element 36 having a central media portion 38 generally surrounded by a peripheral seal portion 40 that sealingly engages inner surface 15 of mask shell 12. Filter element 36 partitions the interior of mask 10 into a first cavity 44 that includes opening 20 and a second cavity 46 which would include a user's oral and nasal vents (not shown) when the mask is engaged with the face of a user, as further discussed below.

In an exemplary embodiment, filter element 36 is removably retained in place by a number of retention mechanisms such as, for example, one or more tabs 42 which extend from inner surface 15 of shell 12, although other suitable retention mechanisms may be employed without varying the scope of the present invention. For example, the present invention contemplates providing filter element between shell 12 and seal element 18 in a gasket-like fashion, with the attachment of the seal element to the shell also holding the filter element in place. The present invention also contemplates providing a slot in shell 12 into which filter element 36 inserts.

Media portion 38 of filter element 36 preferably comprises a high efficient, low resistance, bacteria filtration media. In an exemplary embodiment of the present invention, filter element 36 is a high efficiency particulate air (HEPA) filter that removes at least 99.97% of airborne particles 0.3 micrometers (μm) in diameter. The present invention contemplates that the filter element is in the form of a mat of randomly arranged fibers, the thickness of which depends on the fiber density and diameter. It can be appreciated that the specific type of filter element depends on the actual usage of the masks. The present invention contemplates, for example, that the temperature of the environment in which the filter media is taken into consideration in deciding what type of filter element to use. For example, in a low temperature environment, a low temperature media is used. Such a media, commonly employs a fiber made from polyester felt or polypropylene felt. For a high temperature environment, a high temperature media is used, which typically uses fiber made from high heat resistance materials, such as homopolymer acrylic felt.

Filter element 36 may also be provided with an indicator (not shown) that provides an indication that an effective filtration value of the filtration medium is not met and thus should be replaced. The present invention contemplates that usage indicator includes, for example, moisture sensitive additives that change color when moisture builds up within the filter, CO2 sensitive chemicals that change color due to duration of CO2 it is exposed to, or any other suitable indicator or combination of indicators.

When seal element 18 of mask 10 is positioned against a user's face (not shown), a breathing cavity 46 is formed generally between the user's face and the filter element 36. Seal portion 40 of the filter element 36 ensures that the two cavities 44, 46 are effectively isolated from each other so that any gases passing from the breathing cavity 46 to the first cavity 44, or vice versa, must pass through, and thus be filtered by, the media portion 38 of filter element 36. It is to be appreciated that by placing filter element 36 in close proximity to the user, any concerns of potential gas leaks at valves, swivels, or other connection points is mitigated, as potentially contaminated air exhaled by a user is filtered prior to reaching any such points of concern. Additionally, such placement of the filter element 36 provides for quick and simple replacement of filter elements.

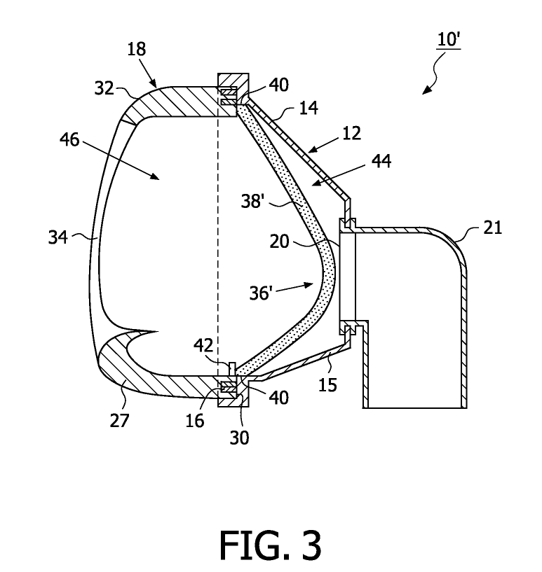

FIG. 3 shows a cross-sectional view of another example of a mask 10′ in accordance with another embodiment of the invention. Mask 10′ differs from mask 10 described above in that filter element 36′ of mask 10′ shown in FIG. 3 is of a generally concave shape curving away from a user's face. Such curvature provides for a larger media portion 38′ and thus a greater effective filtration area (not numbered) than provided by media portion 38 previously discussed. It can be readily appreciated that through such curved design an effective filtration area greater than a projection area of the shell 12 can be readily achieved. Such arrangement is advantageous in that a greater filtration area provides for less pressure drop, or more commonly perceived flow resistance across the filter element 36′. In addition the concave or curved shape for filter element 36, 36′, the present invention contemplates that the filter element can have a variety of different shapes, including pleats, folds, or other configurations to increase the effective surface area of the filter while maintaining the filter at a size sufficient to fit within the respiratory interface device.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A respiratory interface device comprising:
a first portion having one or more openings;
a second portion structured to engage a face of a user; and
a filtration element disposed between the first portion and the second portion, the first portion and the filtration element defining a first cavity, at least the second portion and the filter element being structured to define a facial cavity when the respiratory interface device is in use, the filtration element being structured to filter gases passing from the first cavity to the second cavity and from the second cavity to the first cavity.

2. The respiratory interface device according to claim 1, wherein the respiratory interface device includes a shell, wherein the first portion is part of the shell, and wherein the second portion comprises a seal element coupled to the shell.

3. The respiratory interface device according to claim 1 wherein the one or more openings comprise one or more of a gas inlet, an exhaust mechanism, and an entrainment valve.

4. The respiratory interface device according to claim 1, wherein the filtration element comprises a peripheral seal that sealingly engages the first portion.

5. The respiratory interface device according to claim 4, wherein the filtration element isolates the first cavity and the one or more openings from the second cavity.

6. The respiratory interface device according to claim 5, wherein a fluid coupling device is coupled to one of the one or more openings, and wherein the filtration element isolates the fluid coupling device from the second cavity.

7. The respiratory interface device according to claim 4, wherein the filtration element is releasably coupled to the first portion.

8. The respiratory interface device according to claim 2 wherein the filtration element includes a filtration surface having a filtration area, wherein the shell has a projection area, and wherein the filtration area is greater than the projection area.

9. The respiratory interface device according to claim 1, wherein the filtration element has a concave shape.

10. The respiratory interface device according to claim 1, wherein the second portion is structured to cover at least one of the user's nasal vents and oral vent.

11. The respiratory interface device according to claim 1, wherein the filtration medium comprises a high-efficient, low resistance bacteria filter [what are some values for minimum efficiency and resistance?].

12. The respiratory interface according to claim 1, wherein the filtration element comprises an indicator that provides an indication that the filtration element needs to be replaced.

13. The respiratory interface device according to claim 12, wherein at least a portion of the filtration element is structured to change color when the filtration element needs to be replaced.

14. The respiratory interface device according to claim 13, wherein the filtration element is structured to change color when a moisture level in at least a portion of the filtration element reaches a threshold level.

15. A gas filtration method, comprising:
providing a mask having a first portion having one or more openings provided therein and a second portion structured to engage a face of a user;
isolating the one or more openings from the second portion by providing a filtration element inside the mask between the first portion and the second portion, wherein the first portion and the filtration element define a first cavity within the mask;
attaching the mask to the face of the user, wherein at least the second portion, the filter element and the face of the user define a second cavity;
filtering incoming gases passing from the first cavity to the second cavity with the filtration element; and
filtering exhaust gases passing from the second cavity to the first cavity with the filtration element.

16. The gas filtration method according to claim 15, wherein the one or more openings comprise one or more of a gas inlet, an exhaust mechanism, and an entrainment valve.

17. The gas filtration method according to claim 15, wherein the filtration element includes a filtration surface having a filtration area, wherein the shell has a projection area, and wherein the filtration area is greater than the projection area.

18. The gas filtration method according to claim 15, wherein the filtration element has a concave shape.

19. The gas filtration method according to claim 15, wherein the second portion is structured to cover at least one of the user's nasal vents and oral vent.
